(19) United States
(12) Patent Application Publication
(10) Pub. No.: US 2023/0024489 A1
(43) Pub. Date: Jan. 26, 2023

(54) WIRELESS CHARGING COIL MEMBER AND WIRELESS CHARGING COIL ASSEMBLY

(71) Applicant: Lanto Electronic Limited, Kunshan City (CN)

(72) Inventors: YongJiang GUO, Kunshan City (CN); ZiQiang WU, Kunshan City (CN); Chen CHEN, Kunshan City (CN)

(73) Assignee: Lanto Electronic Limited, Kunshan City (CN)

(21) Appl. No.: 17/516,264

(22) Filed: Nov. 1, 2021

(30) Foreign Application Priority Data
Jul. 21, 2021 (CN) 202110826904.X

(51) Int. Cl. H02J 50/10; H01F 38/14; H01F 27/24; H02J 50/40

(52) U.S. Cl. CPC H02J 50/10; H01F 38/14; H01F 27/24; H02J 50/402

(57) ABSTRACT

A wireless charging coil member and a wireless charging coil assembly. The wireless charging coil member comprises a first coil member, a second coil member, and a side coil member. The first coil member comprises a first coil and a first magnetic core. The first coil is winding around the first magnetic core in a first direction. The second coil member comprises a second coil and a second magnetic core. The second coil is winding around the second magnetic core in the first direction. The first coil member is disposed at one side of the second coil member. The side coil member comprises a side coil and a side magnetic core. The side coil is winding around the side magnetic core in a second direction. The second direction is perpendicular to the first direction. The side coil member is disposed between the first coil member and the second coil member.

### CROSS-REFERENCE TO RELATED APPLICATION

This application claims the priority benefit of Chinese Patent Application Serial Number 202110826904.X, filed on Jul. 21, 2021, the full disclosure of which is incorporated herein by reference.

### BACKGROUND

### Technical Field

The present disclosure relates to the technical field of wireless charging, particularly to a wireless charging coil member and a wireless charging coil assembly.

### Related Art

Along with the advancement of technology, wireless charging techniques have been developing and updating rapidly. The common configuration of a wireless charging device is provided with a coil and a magnetic core, and the winding method of the coil or the structural design of the magnetic core would affect the wireless charging efficiency. At present, conventional wireless charging technology performs charging by the magnetic field interaction between a transmitting coil and a receiving coil. However, the magnetic field energy emitted by the transmitting coil at the transmitting end could not be fully supplied to a charging coil at the charging end in a concentrated manner, where a small part of the magnetic field energy is lost to the outside, which lowers the wireless charging efficiency.

### SUMMARY

The embodiments of the present disclosure provide a wireless charging coil member and a wireless charging coil assembly tended to solve the problem of lowered wireless charging efficiency due to a small part of the magnetic field energy lost to the outside by specific winding method of coil or specific structural design of the magnetic core.

On the first aspect, the present disclosure provides a wireless charging coil member, comprising a first coil member, a second coil member, and a side coil member. The first coil member comprises a first coil and a first magnetic core. The first coil is winding around the first magnetic core in a first direction. The second coil member comprises a second coil and a second magnetic core. The second coil is winding around the second magnetic core in the first direction. The first coil member is disposed at one side of the second coil member. The side coil member comprises a side coil and a side magnetic core. The side coil is winding around the side magnetic core in a second direction. The second direction is perpendicular to the first direction. The side coil member is disposed between the first coil member and the second coil member. Two ends of the side coil are respectively connected with the first coil and the second coil.

In one embodiment, a direction of the magnetic field of the side coil member relative to a direction of the magnetic field of the first coil member is perpendicular to a direction of the magnetic field of the second coil member.

In one embodiment, two ends of the side magnetic core are respectively connected with the first magnetic core and the second magnetic core. The first magnetic core, the second magnetic core, and the side magnetic core are integrally formed.

In one embodiment, the first magnetic core, the second magnetic core, and the side magnetic core are U-shaped.

In one embodiment, the first magnetic core, the second magnetic core, and the side magnetic core is made of ferrite.

In one embodiment, a first electrical connecting piece and a second electrical connecting piece are further provided. One end of the side coil and one end of the first coil being disposed at the first electrical connecting piece. The other end of the side coil and one end of the second coil being disposed at the second electrical connecting piece.

On the second aspect, the present disclosure provides a wireless charging coil assembly, comprising a first wireless charging coil member and a second wireless charging coil member. The first wireless charging coil member comprises a wireless charging coil member according to the first aspect. The second wireless charging coil member comprises a wireless charging coil member according to the first aspect. The first coil member of the first wireless charging coil member corresponds to the first coil member of the second wireless charging coil member. The second coil member of the first wireless charging coil member corresponds to the second coil member of the second wireless charging coil member.

In one embodiment, the first wireless charging coil member is a transmitting end. The second wireless charging coil member is a receiving end.

In the embodiments of the present disclosure, by the interconnection of the first coil member, the second coil member, and the side coil member, a plurality of overflowed magnetic field lines among the coils of the first coil member, the second coil member, and the side coil member can be regained to increase electromagnetic conversion efficiency and improve wireless charging efficiency. Besides, since one of the two wireless charging coil members of the wireless charging coil assembly performs charging while the other is being charged, the wireless charging efficiency can be improved.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a schematic diagram of a wireless charging coil of the first embodiment of the present disclosure;

FIG. 2 is an exploded view of the wireless charging coil of the first embodiment of the present disclosure;

FIG. 3 is an exploded view of a wireless charging coil of the second embodiment of the present disclosure;

FIG. 4 is an exploded view of a wireless charging coil of the third embodiment of the present disclosure;

FIG. 5 is a schematic diagram of the use state of the wireless charging coil assembly of the present disclosure;

FIG. 6 is a schematic diagram of the use state of the wireless charging coil member of the present disclosure; and

FIG. 7 is another schematic diagram of the use state of the wireless charging coil member of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

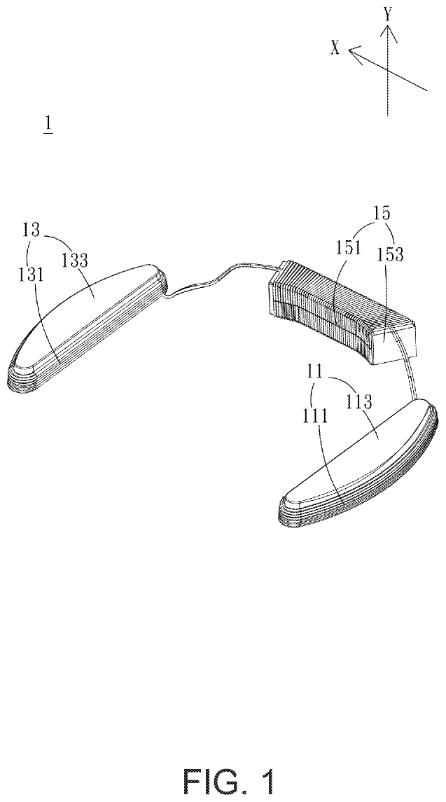

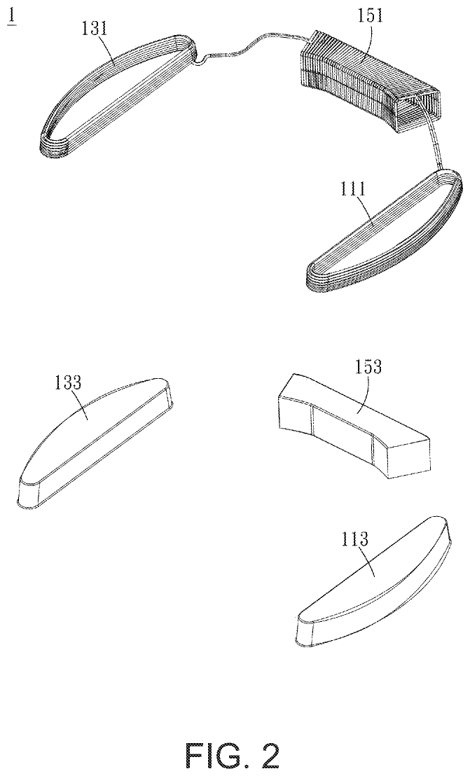

FIG. 1 and FIG. 2 are schematic diagram and exploded view of a wireless charging coil of the first embodiment of the present disclosure. As shown in the figures, a wireless charging coil member 1 is provided, which comprises a first coil member 11, a second coil member 13, and a side coil member 15. The first coil member 11 comprises a first coil 111 and a first magnetic core 113 and is winding around the first magnetic core 113 in a first direction X. The second coil member 13 comprises a second coil 131 and a second magnetic core 133 and is winding around the second magnetic core 133 in the first direction X. The first coil member 11 is disposed at one side of the second coil member 13. The side coil member 15 comprises a side coil 151 and a side magnetic core 153. The side coil 151 is winding around the side magnetic core 153 in a second direction Y. The second direction Y is perpendicular to the first direction X. The side coil member 15 is disposed between the first coil member 11 and the second coil member 13. Two ends of the side coil 151 are respectively connected to the first coil 111 and the second coil 131. When the wireless charging coil member 1 is considered as a transmitting terminal for charging or considered as a receiving terminal to be charged. A direction of the magnetic field of the side coil member 15 relative to a direction of the magnetic field of the first coil member 11 is perpendicular to a direction of the magnetic field of the second coil member 13. Besides, the direction of the magnetic field of the first coil member 11 is opposite to the direction of the magnetic field of the second coil member 13.

The first magnetic core 113 is a flat and long shaped member. The first coil 111 is winding on a side surface of the first magnetic core 113 in a horizontal direction (the first direction X) and is winding along the outer shape of the first magnetic core 113 so that the first coil 111 is flat shaped. The first coil 111 covers the side surface of the first magnetic core 113 and exposes two end surfaces on the upper side and the lower side of the first magnetic core 113. Wherein, the linear directions of the two end surfaces of the first magnetic core 113 are in a vertical direction.

Besides, the second magnetic core 133 is also a flat and long shaped member. The second coil 131 is winding on a side surface of the second magnetic core 133 in a horizontal direction (the first direction X) and is winding along the outer shape of the second magnetic core 133 so that the second coil 131 is flat shaped. The second coil 131 covers the side surface of the second magnetic core 133 and exposes two end surfaces on the upper side and the lower side of the second magnetic core 133. Wherein, the linear directions of the two end surfaces of the second magnetic core 133 are in a vertical direction.

Moreover, the side magnetic core 153 is a long and column shaped member. The side coil 151 is winding on a side surface of the side magnetic core 153 in a vertical direction (the second direction Y) so that the side coil 151 is rectangular shaped. The side coil 151 covers the side surface of the side magnetic core 153 and exposes two end surfaces on the left side and the right side of the second magnetic core 153. Wherein, the linear directions of the two end surfaces of the side magnetic core 153 are in a horizontal direction.

The first magnetic core 113, the second magnetic core 133, and the side magnetic core 153 are made of ferrite. The first coil 111, the second coil 131, and the side coil 151 could generate an alternating magnetic field during charging and being charged. When the magnetic core is made of metal, it would generate electronic eddy currents in the magnetic core material, which would generate a skin effect on the metal material and generate heat on the magnetic core, resulting in a problem of lowered transmission efficiency and waste of electric energy. Besides, the alternating magnetic field would interfere with the surrounding devices and affect the regular operation of the charger. In this way, materials having shielding or wave absorbing properties to block the overflow of magnetic field lines to realize a safe and efficient operation of wireless charging devices. Thus, the magnetic core of this embodiment is made of ferrite to improve the charging efficiency and reduce magnetic interference.

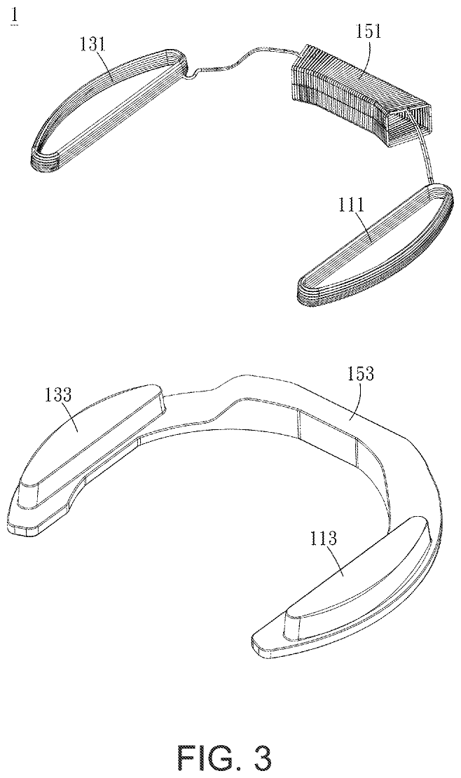

FIG. 3 is an exploded view of a wireless charging coil of the second embodiment of the present disclosure. As shown in the figure, the difference between this embodiment and the first embodiment is the core structural configuration. In this embodiment, two ends of the side magnetic core 153 are respectively connected to a first magnetic core 113 and a second magnetic core 133. The first magnetic core 113, the second magnetic core 133, and the side magnetic core 153 are integrally formed, wherein the first magnetic core 113, the second magnetic core 133, and the side magnetic core 153 are U-shaped. In the present disclosure, the shape of the first magnetic core 113, the second magnetic core 133, and the side magnetic core 153 are not limited which can be selected according to user requirements.

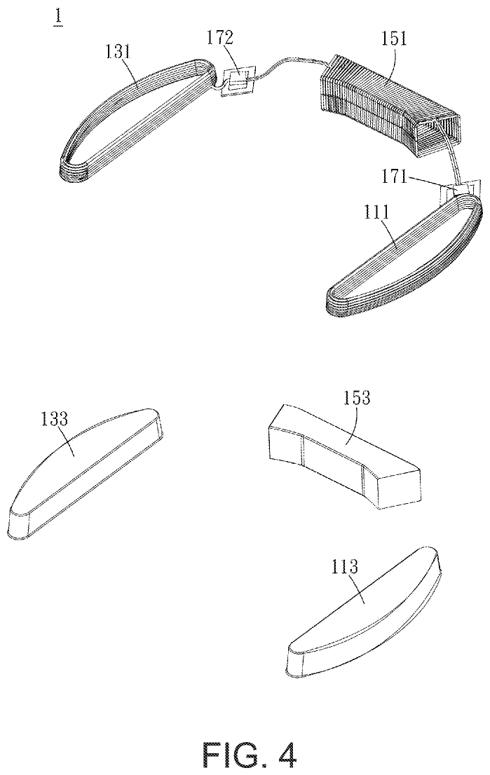

FIG. 4 is an exploded view of a wireless charging coil of the third embodiment of the present disclosure. As shown in the figure, the difference between this embodiment and the first embodiment is that this embodiment further comprises a first electrical connecting piece 171 and a second electrical connecting piece 172. In this embodiment, one end of a side coil 151 and one end of a first coil 111 are disposed at the first electrical connecting piece 171 while the other end of the side coil 151 and one end of the second coil 131 are disposed at the second electrical connecting piece 172. In this way, it is convenient for users to process and connect the coils, or to further connect electronic members such as batteries or control members through the first electrical connecting piece 171 and the second electrical connecting piece 172.

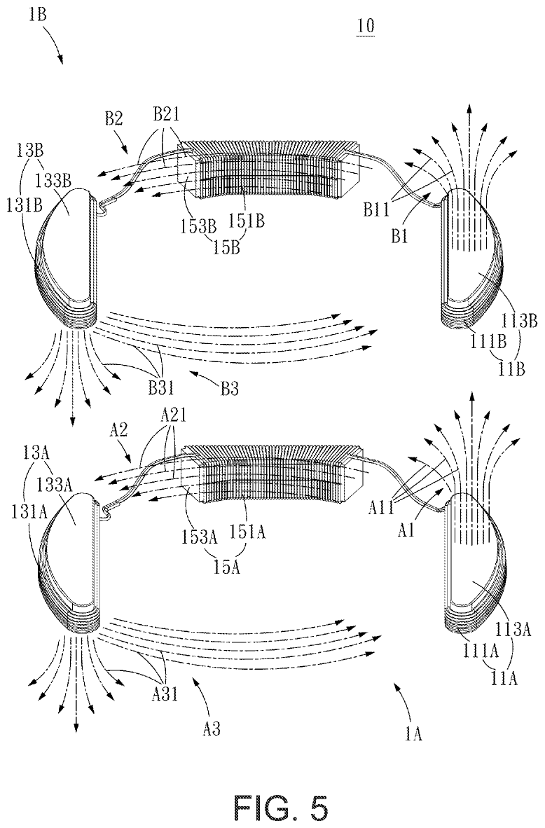

FIG. 5 is a schematic diagram of the use state of the wireless charging coil assembly of the present disclosure. As shown in the figure, a wireless charging coil assembly 10 is provided, which comprises a first wireless charging coil member 1A and a second wireless charging coil member 1B. The first wireless charging coil member 1A comprises a wireless charging coil member 1 in the foregoing embodiment. The second wireless charging coil member 1B also comprises a wireless charging coil member 1 in the foregoing embodiment. Wherein, the first coil member 11A of the first wireless charging coil member 1A corresponds to the first coil member 11B of the second wireless charging coil member 1B. The second coil member 13A of the first wireless charging coil member 1A corresponds to the second coil member 13B of the second wireless charging coil member 1B.

In this embodiment, the first wireless charging coil member 1A is a transmitting end and the second wireless charging coil member 1B is a receiving end. When the first wireless charging coil member 1A wirelessly charges the second wireless charging coil member 1B, it would also charge the first wireless charging coil member 1A. So, the first wireless charging coil member 1A could generate an alternating magnetic field A1, which comprises a plurality of first magnetic field lines A11. The first coil member 11B of the second wireless charging coil member 1B is affected by the alternating magnetic field A1 of the first wireless charging coil member 1A, and the first coil member 11A emits a plurality of first magnetic field lines A11 upwardly, which would affect the first coil member 11B to generate electromagnetic induction. So, the first coil 111B of the first coil member 11B would generate an induced current. The induced current of the first coil 111B of the first coil member 11B mainly goes to the charged element (not shown), and another part of the unused induced current would go to the side coil 151B of the side coil member 15B.

When the first wireless charging coil member 1A wirelessly charges the second wireless charging coil member 1B, the first wireless charging coil member 1A of the transmitting end wirelessly would charge the second wireless charging coil member 1B with a part of the electric current consumed, and the remaining electric current would go to the side coil 151A of the side coil member 15A. Meanwhile, a plurality of first magnetic field lines A11 at one side of the side coil member 15A would affect the side coil member 15A to generate electromagnetic induction, so that the side coil 151A of the side coil member 15A would generate a corresponding induced current.

When the side coil 151A of the side coil member 15A generates electric current, the current of the side coil 151A of the side coil member 15A would continue to go to the second coil 131A of the second coil member 13A. Besides, the current in the side coil member 15A would generate an alternating magnetic field A2 around the side coil 151A. The alternating magnetic field A2 comprises a plurality of side magnetic field lines A21. The plurality of side magnetic field lines A21 close to one side of the second coil member 13A would affect the second coil member 13A to generate electromagnetic induction, so that the second coil 131A of the second coil member 13A would generate a corresponding induced current.

Besides, when the second coil 131A of the second coil member 13A generates electric current, the current in the second coil member 13A would generate an alternating magnetic field A3 around the second coil 131A. The alternating magnetic field A3 comprises a plurality of second magnetic field lines A31. The plurality of second magnetic field lines A31 close to one side of the first coil member 11A would affect the first coil member 11A to generate electromagnetic induction, so that the first coil 111A of the first coil member 11A would generate a corresponding induced current. In this embodiment, through the side coil member 15A and the second coil member 13A, the magnetic field lines overflowed from the first coil member 11A can be regained to enhance the charging efficiency.

Moreover, when the first coil 111B of the second wireless charging coil member 1B at the receiving end generates an induced current, an alternating magnetic field B1 would be generated around the first coil 111B. The alternating magnetic field B1 comprises a plurality of first magnetic field lines B11. The plurality of first magnetic field lines B11 close to one side of the side coil member 15B would affect the side coil member 15B to generate electromagnetic induction so that the side coil 151B of the side coil member 15B would generate a corresponding induced current.

When the side coil 151B of the side coil member 15B generates electric current, the current in the side coil 151B of the side coil member 15B would continue to go to the second coil 131B of the second coil member 13B. Besides, the current in the side coil 15B would generate an alternating magnetic field B2 around the side coil 151B. The alternating magnetic field B2 comprises a plurality of side magnetic field lines B21. The plurality of side magnetic field lines B21 close to one side of the second coil member 13B would affect the second coil member 13B to generate electromagnetic induction so that the second coil 131B of the second coil member 13B would generate a corresponding induced current.

Furthermore, when the second coil 131B of the second coil member 13B generates electric current, the current in the second coil member 13B would generate an alternating magnetic field B3 in the second coil 131B. The alternating magnetic field B3 comprises a plurality of second magnetic field lines B31. The second coil member 13B of the first wireless charging coil member 1A would be affected by the alternating magnetic field B3 of the second wireless charging coil member 1B. The second wireless charging coil member 1B emits a plurality of second magnetic field lines B31 downwardly, which would affect the second coil member 13A to generate electromagnetic induction so that second coil 131A of the second coil member 13A would generate an induced current. Meanwhile, the plurality of second magnetic field lines B31 close to one side of the first coil member 11B would affect the first coil member 11B to generate electromagnetic induction so that the first coil 111 of the first coil member 11 would generate a corresponding induced current.

In this embodiment, the first wireless charging coil member 1A and the second wireless charging coil member 1B generates an alternating current through the first coil member 11, the second coil member 13, and the side coil member 15, and could also receive a plurality of magnetic field lines of force overflowed in the alternating magnetic field formed by the alternating current. In this way, during the charging of the first wireless charging coil member 1A and the second wireless charging coil member 1B, the overflowed magnetic energy can be fully regained to improve the charging efficiency.

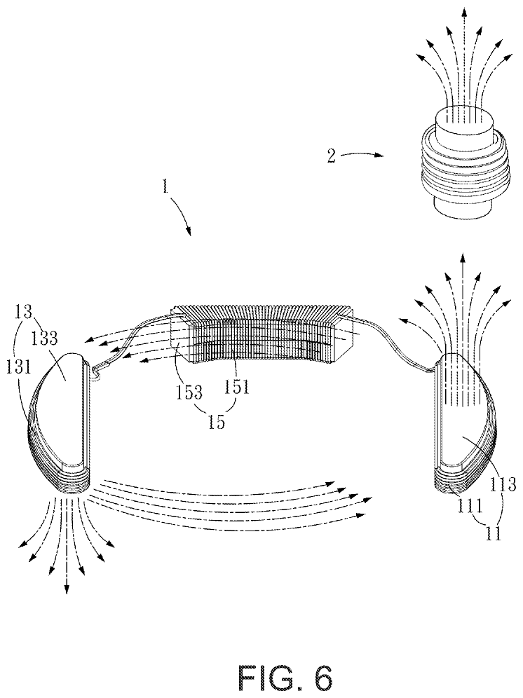

FIG. 6 is a schematic diagram of the use state of the wireless charging coil member of the present disclosure. As shown in the figure, in this embodiment, when a wireless charging coil member 1 wirelessly charges an external coil member 2, the wireless charging coil 1 is considered as a transmitting end. A first coil member 11 of the wireless charging coil member 1 corresponds to a position of the external coil member 2 and implements the current flow state and the electromagnetic induction state of the foregoing first wireless charging coil member 1A for charging, thereby it would not be repeated again.

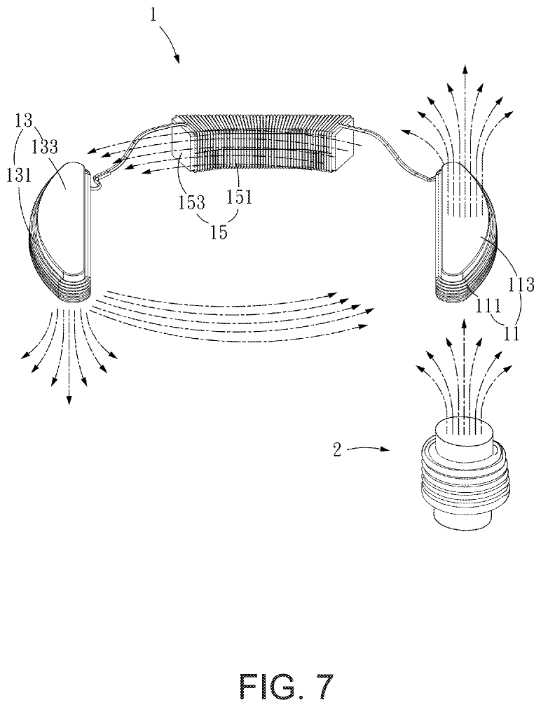

FIG. 7 is another schematic diagram of the use state of the wireless charging coil member of the present disclosure. As shown in the figure, in this embodiment, when an external coil member 2 wirelessly charges a wireless charging coil member 1, the wireless charging coil member 1 is considered as a receiving end. The external coil member 2 corresponds to a first coil member 11 of the wireless charging coil member 1 and implements the current flow state and the electromagnetic induction state of the second wireless charging coil member 1B to be charged, thereby it would not be repeated again.

In summary, embodiments of the present disclosure provide a wireless charging coil member and a wireless charging coil assembly. By the interconnection of the first coil member, the second coil member, and the side coil member, a plurality of overflowed magnetic field lines among the coils of the first coil member, the second coil member, and the side coil member can be regained to increase electromagnetic conversion efficiency and improve wireless charging efficiency. Besides, since one of the two wireless charging coil members of the wireless charging coil assembly performs charging while the other is being charged, the wireless charging efficiency can be improved.

It is to be understood that the term “comprises”, “comprising”, or any other variants thereof, is intended to encompass a non-exclusive inclusion, such that a process, method, article, or device of a series of elements not only comprise those elements but further comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. An wireless charging coil member, comprising:
a first coil member comprising a first coil and a first magnetic core, the first coil being winding around the first magnetic core in a first direction;
a second coil member comprising a second coil and a second magnetic core, the second coil being winding around the second magnetic core in the first direction, the first coil member being disposed at one side of the second coil member; and
a side coil member comprising a side coil and a side magnetic core, the side coil being winding around the side magnetic core in a second direction, the second direction being perpendicular to the first direction, the side coil member being disposed between the first coil member and the second coil member, two ends of the side coil being respectively connected with the first coil and the second coil.

2. The wireless charging coil member according to claim 1, wherein a direction of the magnetic field of the side coil member relative to a direction of the magnetic field of the first coil member is perpendicular to a direction of the magnetic field of the second coil member.

3. The wireless charging coil member according to claim 1, wherein two ends of the side magnetic core are respectively connected with the first magnetic core and the second magnetic core; the first magnetic core, the second magnetic core, and the side magnetic core are integrally formed.

4. The wireless charging coil member according to claim 3, wherein the first magnetic core, the second magnetic core, and the side magnetic core are U-shaped.

5. The wireless charging coil member according to claim 1, wherein the first magnetic core, the second magnetic core, and the side magnetic core is made of ferrite.

6. The wireless charging coil member according to claim 1 comprising a first electrical connecting piece and a second electrical connecting piece, one end of the side coil and one end of the first coil being disposed at the first electrical connecting piece, the other end of the side coil and one end of the second coil being disposed at the second electrical connecting piece.

7. A wireless charging coil assembly, comprising:
a first wireless charging coil member comprising a wireless charging coil member according to claim 1; and
a second wireless charging coil member comprising a wireless charging coil member according to claim 1, wherein the first coil member of the first wireless charging coil member corresponds to the first coil member of the second wireless charging coil member; the second coil member of the first wireless charging coil member corresponds to the second coil member of the second wireless charging coil member.

8. The wireless charging coil assembly according to claim 7, wherein the first wireless charging coil member is a transmitting end; the second wireless charging coil member is a receiving end.
